(19) United States
(12) Patent Application Publication
(10) Pub. No.: US 2002/0162503 A1
(43) Pub. Date: Nov. 7, 2002

(54) Application device

(76) Inventors: Kurt Eichinger, Williamsburg (AT); Lothar Pfalzer, Ravensburg (DE)

Correspondence Address: Todd T Taylor, Taylor & Aust, 142 South Main Street, PO Box 560, Avilla, IN, 46710, US

(21) Appl. No.: 10/070,269

(22) PCT Filed: Jun. 29, 2001
(86) PCT No.: PCT/DE01/02426

(30) Foreign Application Priority Data
Jul. 4, 2000 (DE) 100 32 500.9

(51) Int. Cl. B05C 3/00

(52) U.S. Cl. 118/405; 118/419; 118/427

(57) ABSTRACT

The invention relates to a device for the application of a liquid medium onto at least one side of a moving material web, specifically a cardboard web; comprising at least one roll (1; 1a) that supports the web (3) and at least one feed device (5; 5a) for the coating medium, whereby during operation of the device a liquid sump (6; 6a) forms between the roll (1; 1a) and the web (3). According to the invention, the nozzle lips (13, 14; 13a, 14a) of a nozzle body (12, 12a) of the feed device (5, 5a) are configured so that the desired dimension of the open surface of the sump (6, 6a) and the depth of immersion of the nozzle lips (13, 14; 13a, 14a), and thereby the level (P) of the sump (6, 6a) are adjustable. The nozzle lips are surrounded to 80% of their total length—starting from the nozzle opening (15, 15a)—by the sump (6, 6a).

The invention relates to a device for the application of a liquid medium onto a moving material web, specifically a cardboard web, and comprising the characteristics in accordance with the general terms cited in claim 1.

Generic devices are used for the purpose of impregnating and/or coating a fiber web, for example a paper or cardboard web with a liquid medium during the manufacturing, processing or converting process. Generally used coating mediums are glue, starch or a color pigment containing suspensions or dispersions. This processing of the web is intended to alter and improve certain web characteristics.

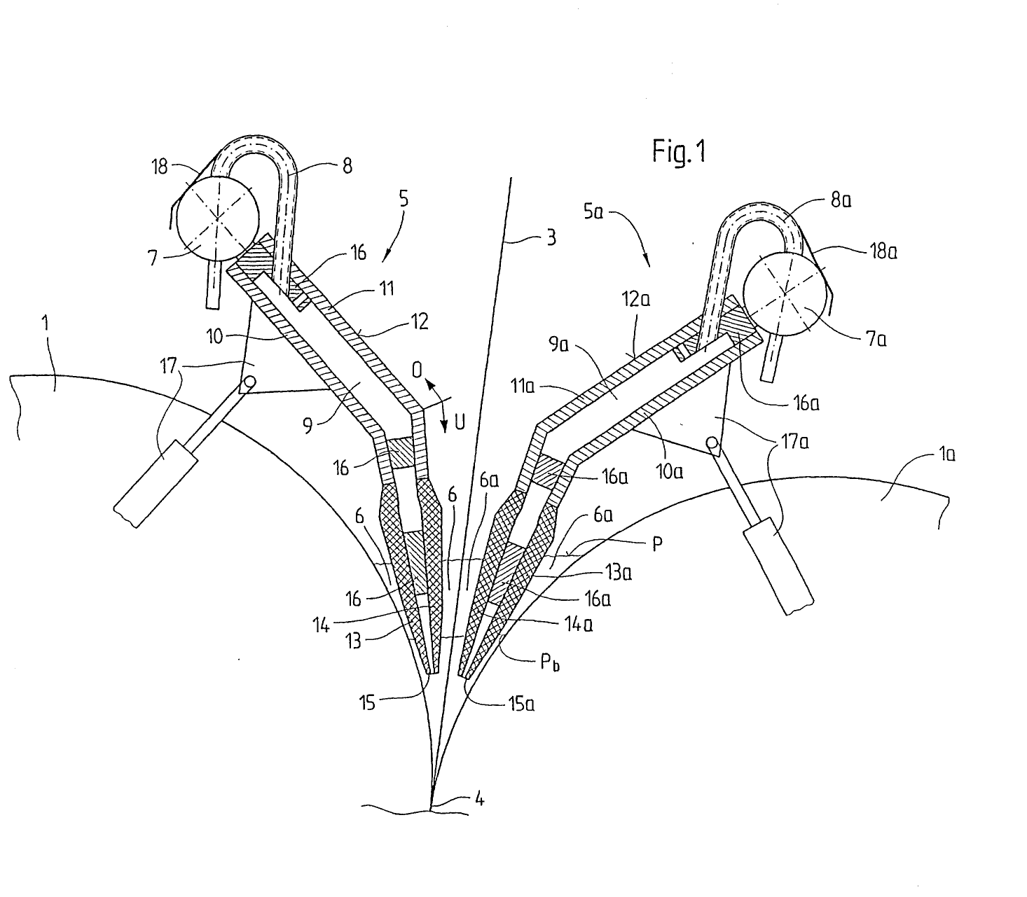

The Voith publication p 2745, FIG. 1 describes a so-called size press. The size press comprises two parallel rolls which form a nip through with the paper web travels. During operation of the device there is a liquid sump between the web and each of the two rolls, so that the web is impregnated simultaneously from both sides.

This device has the disadvantage that—with increasing web speed—the liquid in the sump is subject to very high turbulence, causing the liquid to splash into the surrounding area (for example onto device components and onto the web), resulting in that a uniform application onto the web is no longer possible.

An attempt was made with the device described in DE 29513970 to avoid splashing with the help of displacers or stabilizers. However, this device has not proven completely satisfactory during operation. Coating medium feed devices that dip into the sump are already known from DE 29610446.

A method and a device comprising a feed device that dips into the sump are also known from U.S. Pat. Nos. 4,358,484 and 4,407,224. In each case the feed device comprises a main distributor tube that is equipped with delivery openings along its entire length, whereby these delivery openings are connected with a flow channel for the formation of the sump. The flow channel is part of a nozzle body. The nozzle body comprises parallel walls, extending across the entire width of the device. Nozzle lips that are located on these walls dip into the sump. The nozzle body is divided in its center by a wall into the aforementioned flow channel in order to supply the sump, and into another channel for discharging the medium of the sump by means of vacuum in order to create a reservoir. In the loop, medium is supplied from the reservoir to the sump, and again discharged.

It is the intent of these solutions to keep the depth of the sump as low as possible in order to avoid splashing and significant turbulence.

The design of these devices is however relatively expensive, since there is also a collection chamber at the discharge channel from which the medium must be pumped into the reservoir. Moreover, the entire device is permanently installed.

In the event of a roll change the entire device must be dismantled which is very labor and cost intensive.

The objective of the current invention therefore is, to improve the device referred to under the generic term with regard to ease of cleaning, ease of operation and ease of adaptation to specific application situations, at the same time largely avoiding splashing from the sump.

The current invention meets the objective through the characteristics of the criteria cited in claim 1.

The inventor has recognized that, considering the current high operating and web speeds, the depth of the sump is not the decisive factor for a splash-free operation and a uniform coating application, but rather, that it is necessary to reduce the sump surface area. Surprisingly, it is even advantageous to let the sump level rise. This achieves a longer dwell time of the web in the sump (without causing saturating and/or breaking of the web), resulting in better penetration and uniformity of the coating application.

The desired dimension of the open sump surface can be adjusted by special nozzle lips, which are selected from a modular system and are matched precisely to the sump cross section in shape and size.

The nozzle lips are appropriately manufactured from a synthetic material. They can easily be manufactured in any desired shape and size and can easily be screwed or clipped onto the walls of the nozzle body.

During trials an immersion depth of up to approximately 80% of the height (or length) of the nozzle lips has proven to be the most effective in avoiding splashing and unevenness in the application, and impregnation of the web.

It is especially advantageous if the entire delivery device is connected with a pivoting device. This allows the delivery device to be pivoted from the nip so that on the one hand, sufficient space remains to clean the roll, or rolls and on the other hand, the device need not be removed if one or both rolls need to be replaced. The pivoting arrangement should therefore be supported separately from the roll supports, in order to accommodate the last cited instance.

Another, significant advantage of the device in accordance with the invention is the structural shape of the nozzle body. In accordance with the invention, the nozzle body is kinked or bent starting from the nip toward the outside. The shape is chosen so that approximately a shape that is approximated to the roll is obtained. The lower section of the nozzle body is also matched to the form of the gusset (which is filled by the sump) existing between the roll and the supported, moving material web.

It is also conceivable in this instance that the nozzle body is equipped with a joint, so that the desired deflection angle can be adjusted.

This aforementioned structural shape has the additional advantage that the device is very compact. It distinguishes itself through a low construction height and also allows the operators a sufficiently clear view of the roll, or rolls of the so-called size press or film press. With regard to operational safety the entire design offers a particularly effective nip protection for the operating personnel.

It must also mentioned that—for the purpose of one-sided application—the device in accordance with the invention is located and active only on one side. For the purpose of two-sided application, devices in accordance with the invention are located on both sides of the material web. Mention must also be made of the fact that, in place of the rolls other types of support elements may be utilized, for example moving, flexible continuous belts.

It is effective if the nozzle that is formed by the lips of the nozzle body discharges the coating medium that is supplied to the sump directly downward, that is in the direction of the gusset tip. This ensures that the coating medium reaches the lowest point of the gusset and can therefore, be pressed reliably into the material web in the nip.

The medium discharging from the nozzle, the rolls or the support belts and also the moving material web have the same direction of travel. However, vortex formation can occur at especially high operating speeds, thereby possibly negatively influencing the coating application results.

Therefore another effective solution may be in the formation of the nozzle as a baffle nozzle. By locating a baffle-strip a small distance below the discharge opening, the arriving coating medium is redirected in radial direction. The hereby created cross flows reduce the undesirable vortex formation.

Other effective variations of the invention result from the sub-claims.

The current invention is further explained below, with the assistance of one embodiment example.

FIG. 1:

Cross section of the roll in a size press comprising the delivery system in accordance with the invention, and a first variation of a nozzle

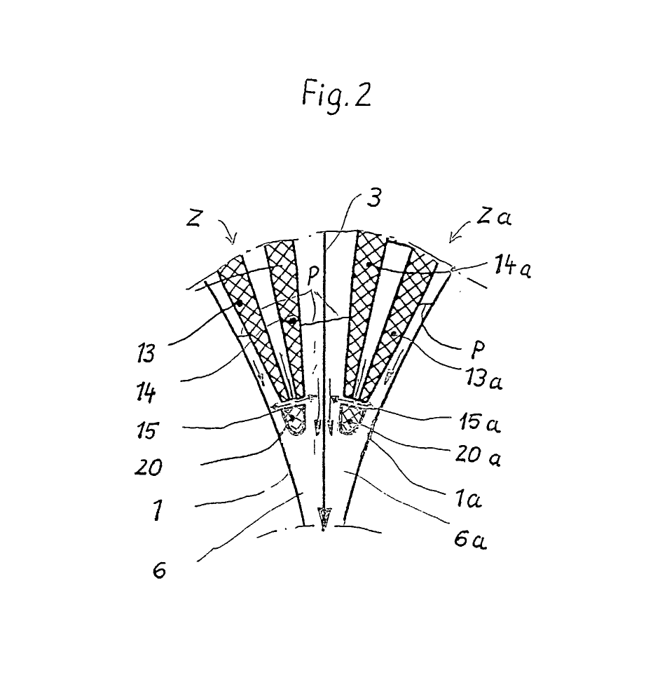

FIG. 2:

Cross section of a second embodiment of the nozzle in accordance with the invention (detailed illustration).

FIG. 1 illustrates two rolls 1 and 1a which, together, form a nip (press nip) 4 through which the cardboard web 3 travels. The web 3 travels through the nip 4 essentially from the top downward, whereby the angle of web entry into the nip is also adjustable, however not illustrated here.

In the chosen example a coating medium 5 and 5a is located on each side of the web 3 for a simultaneous two-sided application of the liquid medium—i.e. starch—onto the web 3. Between the respective web side and each of the rolls 1 and 1a there is a so-called gusset Z and Za. During operation a sump 6 from which the web is coated forms in this gusset Z and Za (based on the web characteristics the respective process is impregnating, sizing or coating).

In the chosen example the delivery system 5 and 5a comprises a main distributor pipe 7 or 7a. This main distributor pipe is machine-wide and receives the coating medium at the end faces. A multitude of curved individual distributor pipes 8 and 8a that are located uniformly along the length of the main distributor pipe discharge into the main distributor pipe 7 and 7a. Through these pipes 8 and 8a precisely targeted volumes of coating medium can be fed into a metering slot, so that a uniform supply is possible across the entire width, and thereby a uniform pressure distribution.

A cover plate 18 and 18a protects the distributor pipes 8 and 8a from contamination. Additionally this provides a largely closed, compact construction style of good design.

The metering slot 9 and 9a is located in the space between parallel walls 10 and 10a, as well as 11 and 11a that are extending across the entire width of the device; whereby walls 10 and 11 respectively form a nozzle body 12 and the walls 10a and 11a form a nozzle body 11a and 12a.

The lower section of the nozzle body 12 and 12a—that is the part which dips into the sump 6—consists of specially formed nozzle lips 13 and 14, and 13a and 14a, effectively converging toward each other.

The nozzle lips always leave a nozzle opening 15 and 15a open between themselves at their lower open end, from which the coating medium gets down into the tip of the gusset Z and Za, thereby creating, or maintaining the sump 6 and 6a.

FIG. 2 illustrates a second embodiment of the nozzle 15 and 15a. The remaining construction of the applicator device in accordance with this second variation is otherwise essentially identical to the design illustrated in FIG. 1. For this reason, the same references are used.

FIG. 2 illustrates that the coating medium is redirected by a flow enhancing baffle strip 20 and 20a. The nozzle openings 20 and 20a can, therefore, be designated as cross flow openings from which the medium is always dispensed in radial direction toward the material web that is being processed and the roll 1 and 1a. The flow directions are indicated by small arrows in FIG. 2.

Vortex formations in the sump can be further reduced by utilizing the second nozzle configuration.

In accordance with fluidic technology the strip 20, 20a is conical in shape and rounded at the end pointing toward the gusset tip. This strip is either a component of the complete nozzle body 12 and 12a, or part of an individual nozzle lip 13, 13a, 14 or 14a, or a separate part.

Based on how the cross section or shape of the individual nozzle lips is formed and on how they are mounted to the walls 9, 10 and 9a and 10a, the size of the open surface area of the sump 6 and 6a, as well as the immersion dept of the nozzle lips can be adjusted. This means that, depending on how deep the nozzle lips dip into the sump, the sump level can be raised or lowered. A better penetration is reached with a higher level, due to the longer dwell time. The immersion dept may be up to 80% of the total nozzle lip length. Turbulence and splashing can be greatly reduced in the device, despite the higher level.

For the sake of clarity, the level in accordance with the existing state of the art is indicated with Pb (for level, previously) in FIG. 1 and as P for the adjusted level in accordance with the current invention.

The nozzle lips are manufactured in various sizes from synthetic material. They are simple to manufacture and to store, easy to clean, non-sensitive to corrosion and are light weight.

From FIG. 1 it can also be seen that the nozzle body 12, 12a, that is, its walls 10, 11 and 10a, 11a are two-part—consisting of an upper section O and a lower section U. Upper section and lower section are detachable, i.e. through screws or joints. The nozzle lips 13, 14 and 13a, 14a are fastened to the lower section U.

This two-part design offers advantages during fabrication, as well as during assembly, dismantling or cleaning.

Moreover, kits in various lengths and widths can be provided for the upper section O and the lower section U, allowing the device in accordance with the invention to also be adapted to coaters having other roll diameter, without incurring large expenses.

Also, the walls of the nozzle body 12, 12a are curved, or as illustrated in FIG. 1, kinked toward the direction of the roll. This design makes it possible for the total device to have a low construction height, thereby offering better stability. This adaptation also slows the flow of the medium in the metering slot 9, 9a, thereby providing further uniformity. This structural form also provides an effective nip-inlet protection.

This means that the operating personnel monitoring this process, cleaning rolls, etc. cannot be drawn into the nip by body parts or clothing.

In addition, the upper section of the nozzle body (this could also apply to the nozzle lips) is fabricated from rust-free sheet metal and equipped with only a few individual stiffening ribs 16, 16a, resulting in a relatively light construction of the entire device.

It is of course possible to mount the entire delivery device 5, 5a rigidly on the housing of the roll mounting.

As illustrated in FIG. 1, pivoting devices 17, 17a are provided in the chosen example with which, on the one hand, the position of the nozzle body with its nozzle opening is adjustable. On the other hand, the entire feed device can be pivoted from the rolls, or from the gusset Z, ZA with the sump 6, 6a, in the event that the web is not being processed, or for clean-up or replacement of the rolls. Total dismantling of the device is therefore no longer necessary.

It should be mentioned one more time that the device illustrated in FIGS. 1 and 2 is intended for two-sided, normally simultaneous application onto both sides of the web 3.

Many times only single-sided application onto only one of the two sides of the web 3 is intended. On the right hand (mirror image) side of the illustration all device components are supplemented with “a”.

In the event of the aforementioned single-sided application the components on the left or the right side of the illustration can be completely eliminated, or simply pivoted out of the way.

It must also be mentioned that the feed device 5, 5a as well as the pivoting device 17, 17a are operable independently of each other.

Component Identification

| | |
|---|---|
| Roll | 1, 1a |
| Web | 3 |
| Nip | 4 |
| Feed device | 5, 5a |
| Sump | 6, 6a |
| Main distributor pipe | 7, 7a |
| Individual distributor pipe | 8, 8a |
| Metering slot | 9, 9a |
| Wall | 10, 10a |
| Wall | 11, 11a |
| Nozzle body | 12, 12a |
| Nozzle lip | 13, 13a |
| Nozzle lip | 14, 14a |
| Nozzle opening | 15, 15a |
| Pivoting device | 17, 17a |
| Cover plate | 18, 18a |
| Baffle plate | 20, 20a |
| Upper section | O |
| Lower section | U |
| Gusset | Z, Za |

Patent claims

1. Device for the application of a liquid medium onto at least one side of a moving material web, specifically a cardboard web, comprising
a) at least one roll (1; 1a) that is supporting the web (3);
b) at least one (5; 5a) for the coating medium, whereby a liquid sump (6; 6a) is formed between the roll (1; 1a) and the web (3) during operation, whereby
c) the at least one (5; 5a) comprises a nozzle body (12; 12a);
d) the nozzle body consists of parallel, machine wide walls (10, 11, 10a, 11a) between which a metering slot (9; 9a) is located, that discharges into a nozzle opening (15; 15a);
e) the nozzle body (12; 12a) is equipped with nozzle lips (13, 14, 13a, 14a);
f) the nozzle lips (13, 14, 13a, 14a) dip into the liquid sump (6, 6a) with their nozzle opening (15, 15a);
characterized in that
g) the shape and size of the nozzle lips (13, 14, 13a, 14a) are configured such, and can be mounted to the walls (10, 11, 10a, 11a) of the nozzle body (12, 12a) such, as to enable adjustment of the desired dimension of the open surface of the sump (6, 6a) and
h) the depth of immersion of the nozzle lips (13, 14; 13a, 14a) and thereby the level (P) of the sump (6, 6a) is adjustable so that the nozzle lips are surrounded to 80% of their total length—starting from the nozzle opening—by the sump (6, 6a).

2. Device in accordance with claim 1, characterized in that
the (5; 5a) consists of a main distributor pipe (7; 7a) into which a multitude of individual distributor tubes (8; 8a) that are located uniformly across the entire machine width and which, in turn, are connected with the nozzle body (12; 12a) discharge.

3. Device in accordance with claim 1 and 2, characterized in that
the nozzle lips (13, 14 and 31a, 14a) are mounted to the walls (10, 11; 10a, 11a) of the nozzle body (12, 12a), whereby the nozzle lips are designed to be replaceable.

4. Device in accordance with claim 1 to 3, characterized in that
the nozzle body (12, 12a can be angled so that it can essentially be matched to the cross sectional shape of the roll (1, 1a).

5. Device in accordance with claim 1 to 4, characterized in that
the nozzle body (12, 12a) is a two-part construction, consisting of an upper section (o) and a lower section (U), whereby the upper section and the lower section are pivoted

6. Device in accordance with claim 3 to 5, characterized in that
the nozzle lips (13, 14; 13a, 14a) are located on the lower section (U) of the nozzle body (12, 12a).

7. Device in accordance with claim 1 to 6, characterized in that
the nozzle opening (15m 15a) that is formed by the nozzle lips (13, 14; 13a, 14a) is located so that the coating medium flows from the nozzle opening (15, 15a) approximately parallel to the direction of travel of the roll (1, 1a) and the material web (3).

8. Device in accordance with claim 1 to 6, characterized in that
the nozzle lips (13, 14; 13a, 14a) together with a baffle strip (20, 20a) form the nozzle opening (15, 15a), so that the coating medium discharges from the aforementioned nozzle opening (15, 15a) in the form of a radial cross flow.

9. Device in accordance with one or several of the aforementioned claims characterized in that
the (5, 5a) is connected with at least one pivoting device (17, 17a).

10. Device for two-sided application of a liquid medium onto a moving material web (3) comprising the characteristics of one or several of the aforementioned claims, whereby two rolls (1 and 1a) are provided which, together form a nip (4) through which the web travels and whereby on both side of the web (3) a second (5a) is located, so that a second sump (6a) forms and both s (5, 5a) can be supplied with coating medium, independent from each other.

11. Device in accordance with claim 10, characterized in that
a second pivoting device (17a) is provided, whereby both pivoting devices (17, 17a) can be operated, independent from each other.
